(19) United States
(12) Patent Application Publication
(10) Pub. No.: US 2003/0023533 A1
(43) Pub. Date: Jan. 30, 2003

(54) Multi-dimensional method and system of simulating and managing an "Alliance Investment Portfolio"

(76) Inventor: Meng Ngee Philip Tan, Singapore (SG)

Correspondence Address: Wen Liu, LIU & LIU LLP, 811 West 7th Street, Suite 1100, Los Angeles, CA, 90017, US

(21) Appl. No.: 10/136,759

(22) Filed: Apr. 30, 2002

Related U.S. Application Data
(60) Provisional application No. 60/287,975, filed on Apr. 30, 2001.

(51) Int. Cl. G06F 17/60

(52) U.S. Cl. 705/36

(57) ABSTRACT

The present invention is a novel method simulating and managing an alliance investment portfolio. It begins with the rationalization and creation of select alliances to become assets of an investment portfolio. The assets are categorized into a matrix combination of nine different financial variations that respond to the iterative nature of investment dynamics. Each of the select alliance is subjected to a ball and prism test determining the sustainability of growth of such alliance within the investment portfolio. Finally, the liquidity to be provided by investors to a vertical axis through the center of matrix combination of nine different financial variations in creating spatial representation of liquidity ad leverage relationship for alliance investments. Through the 3×3×3 alliance mix representation, one could derive valuation, pricing and other portfolio management information for alliance portfolio transparently and dynamically.

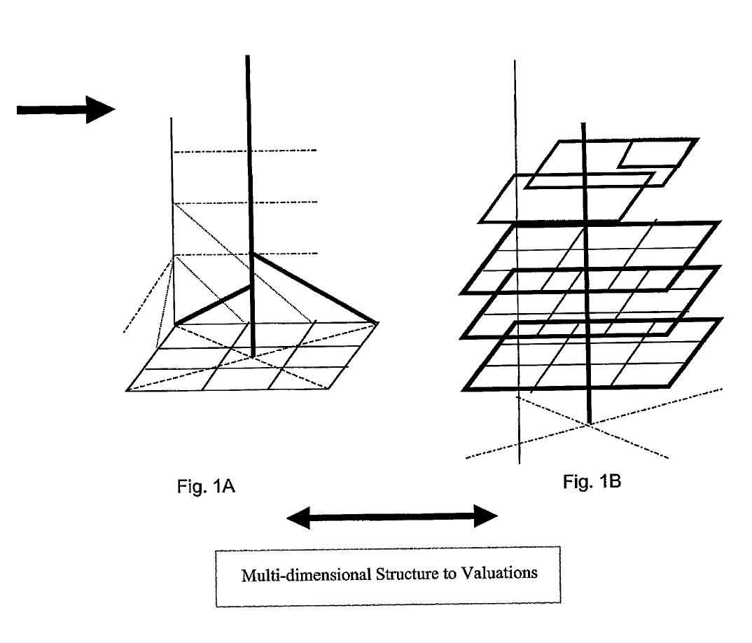

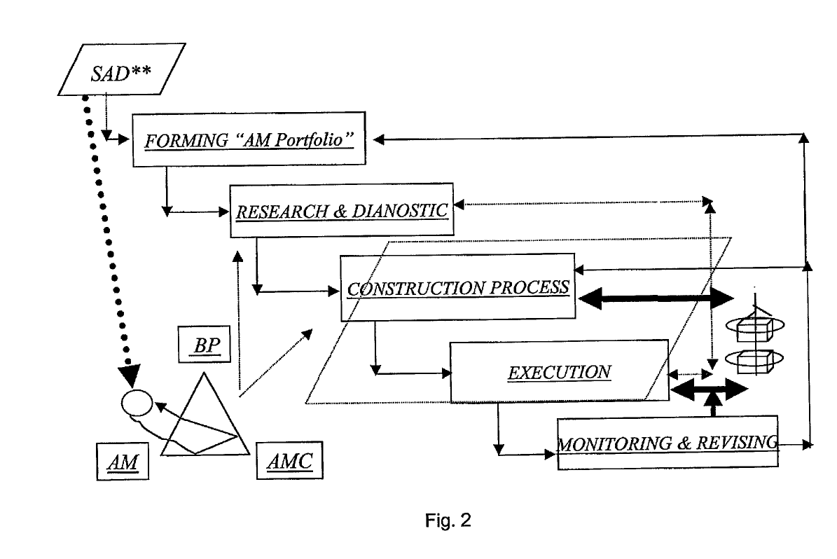

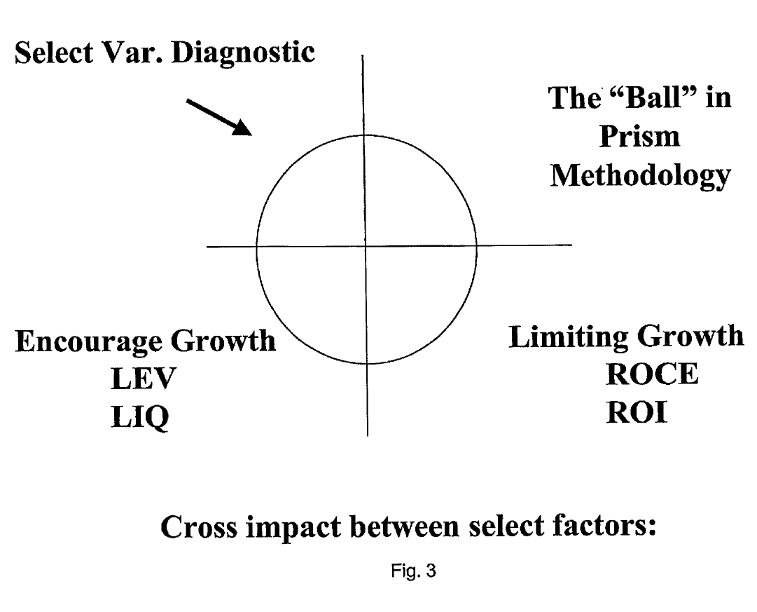

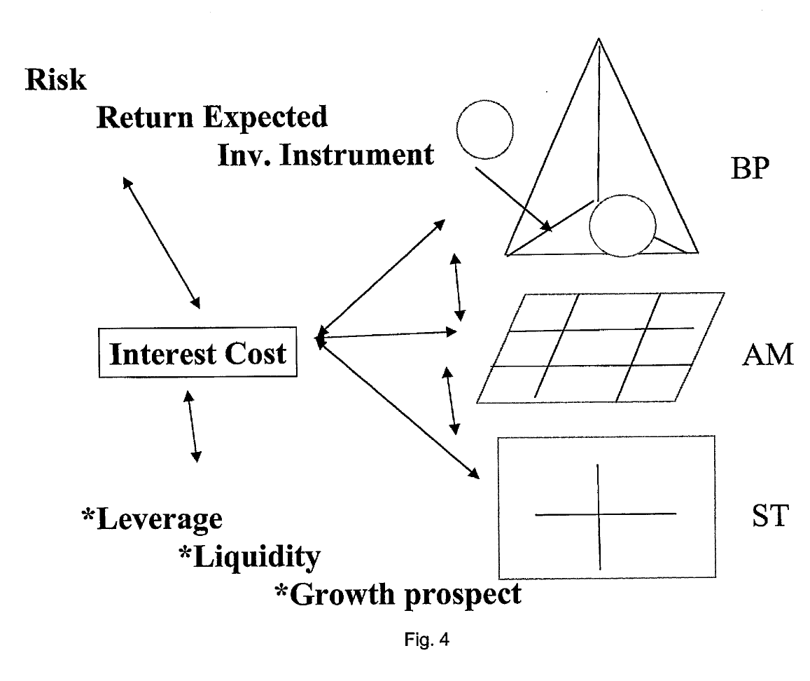

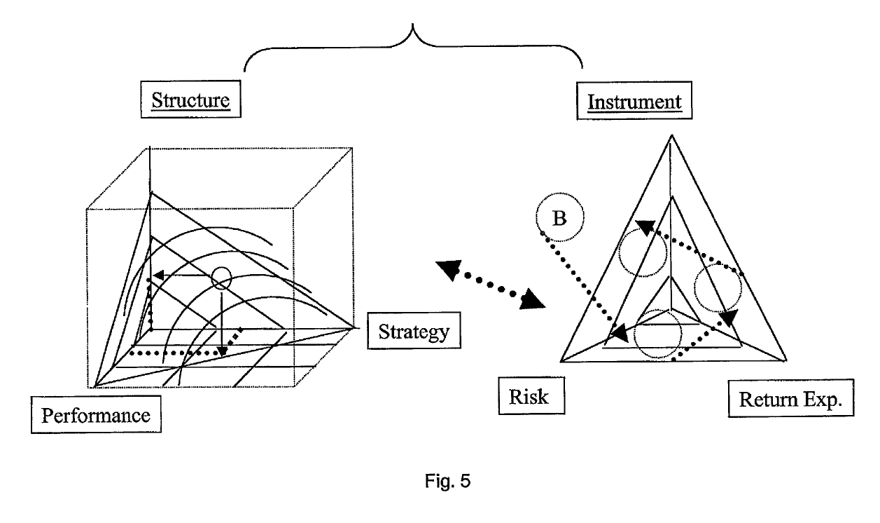

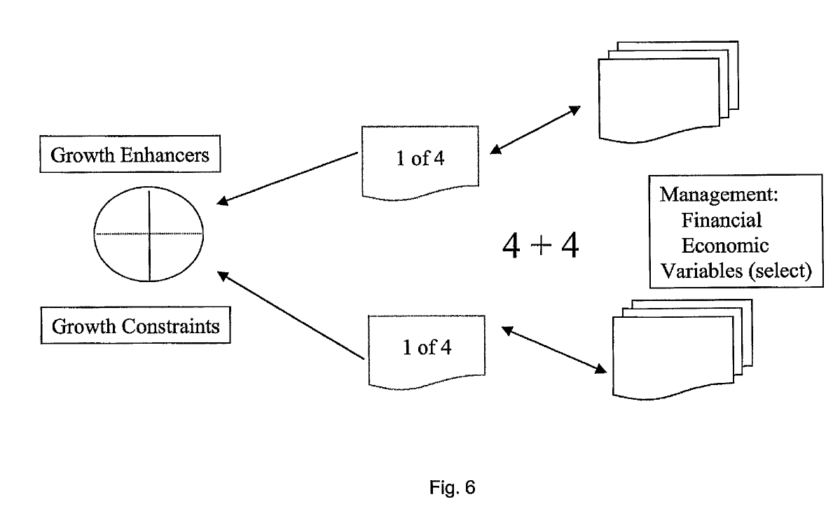

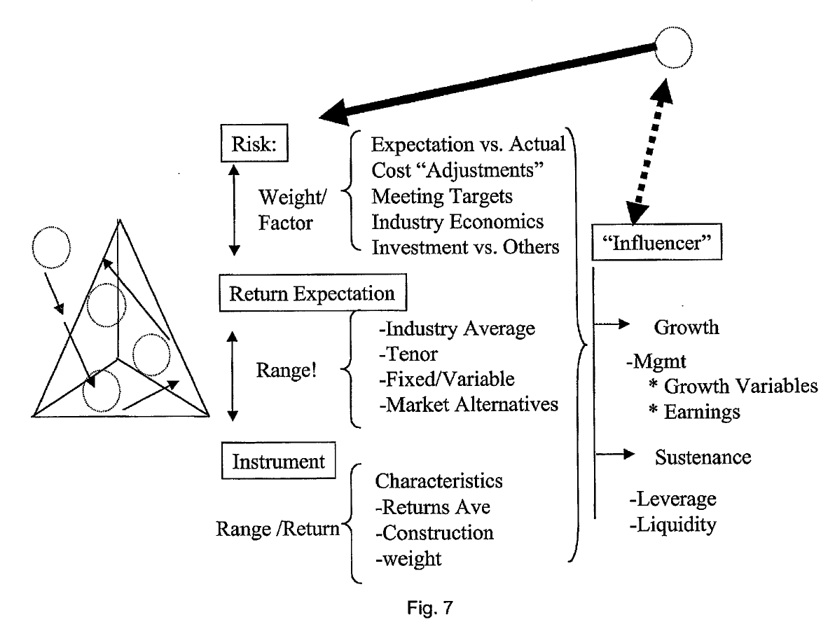

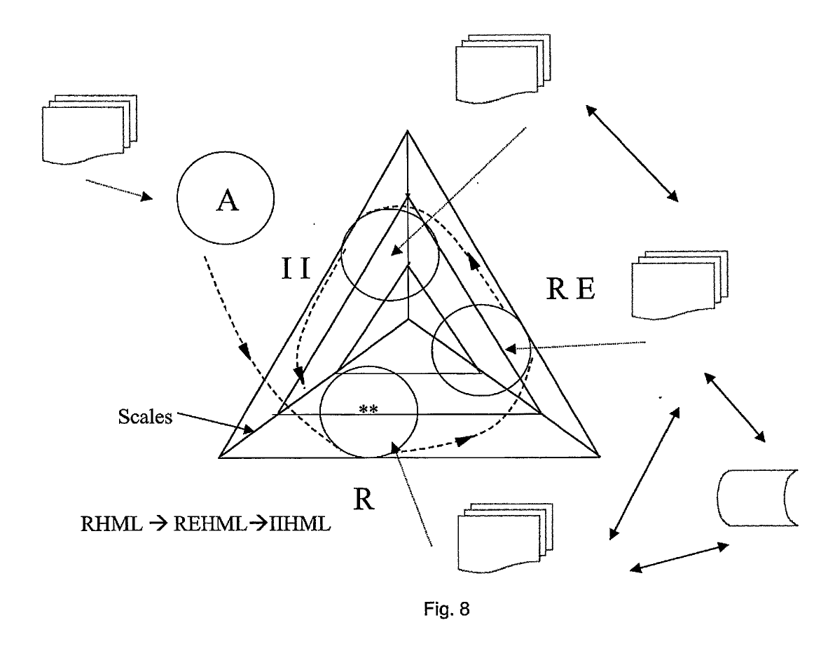

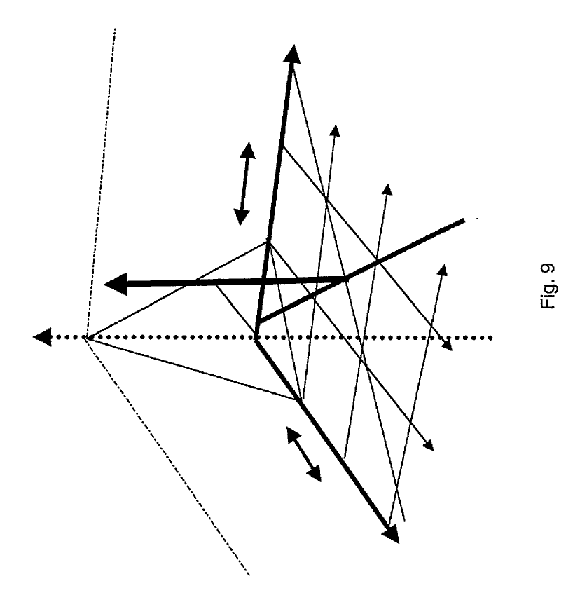

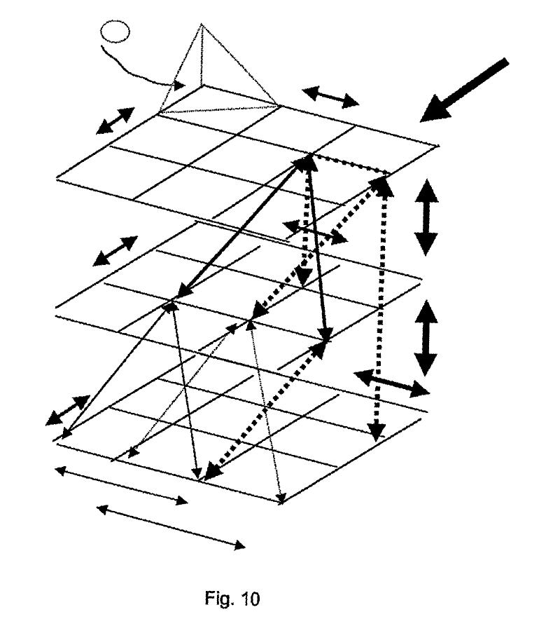

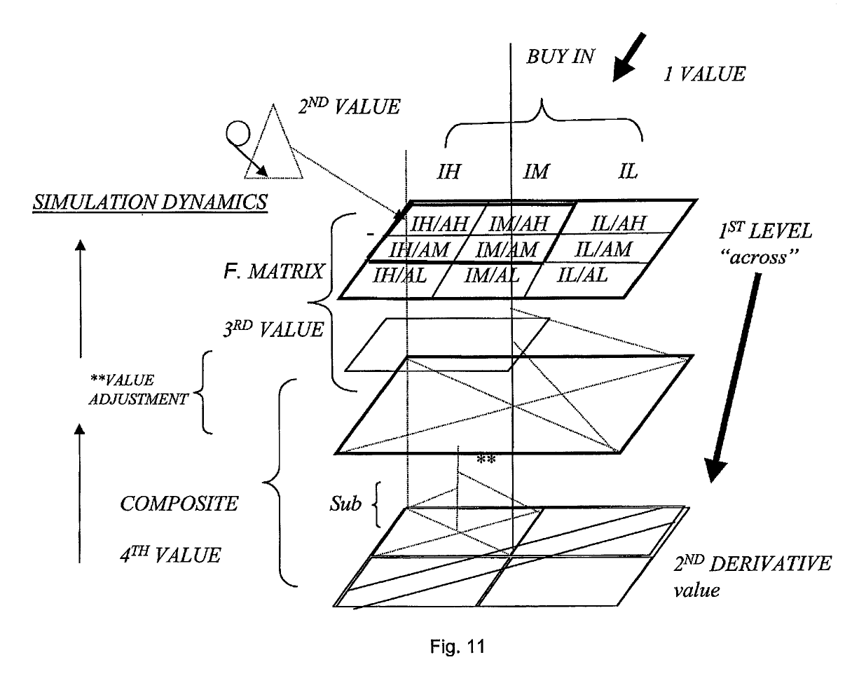

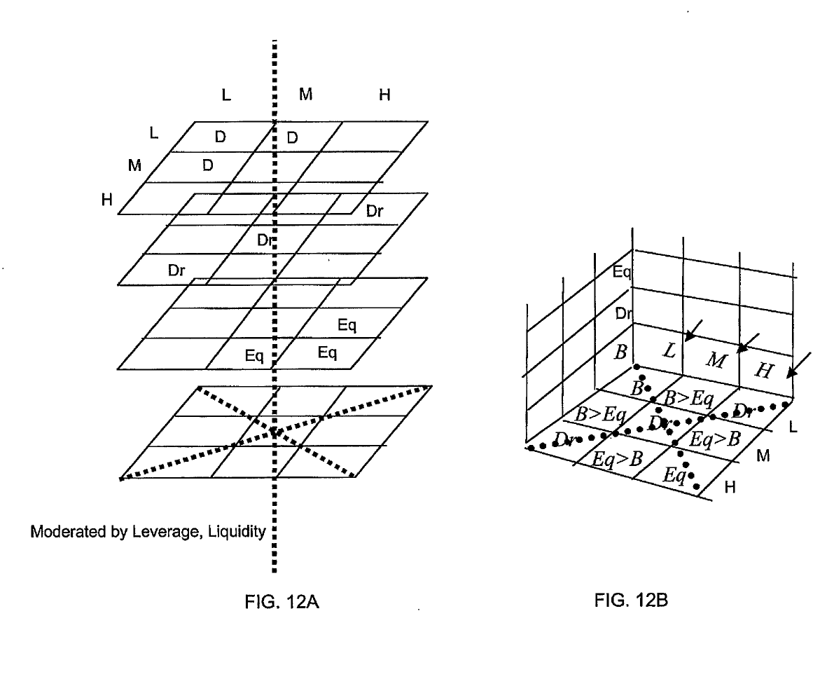

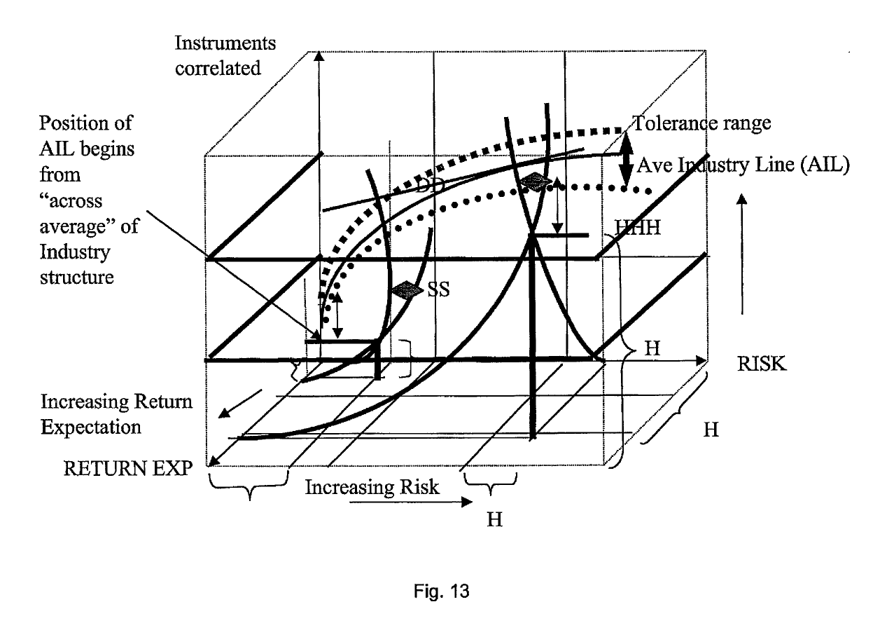

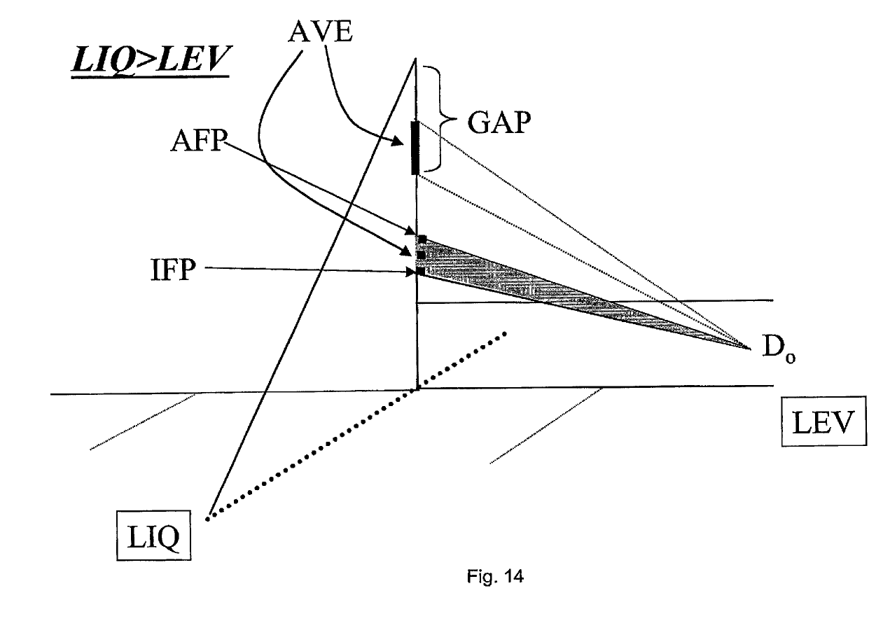

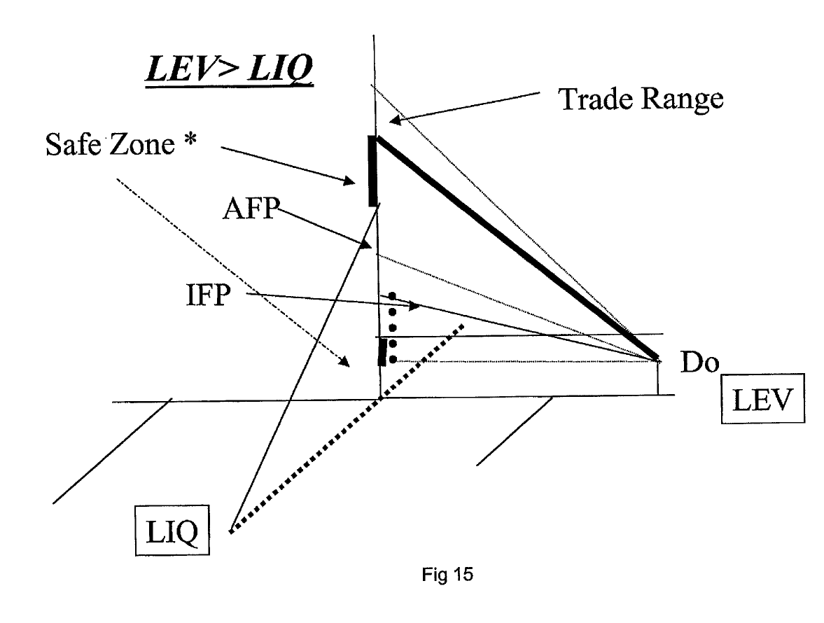

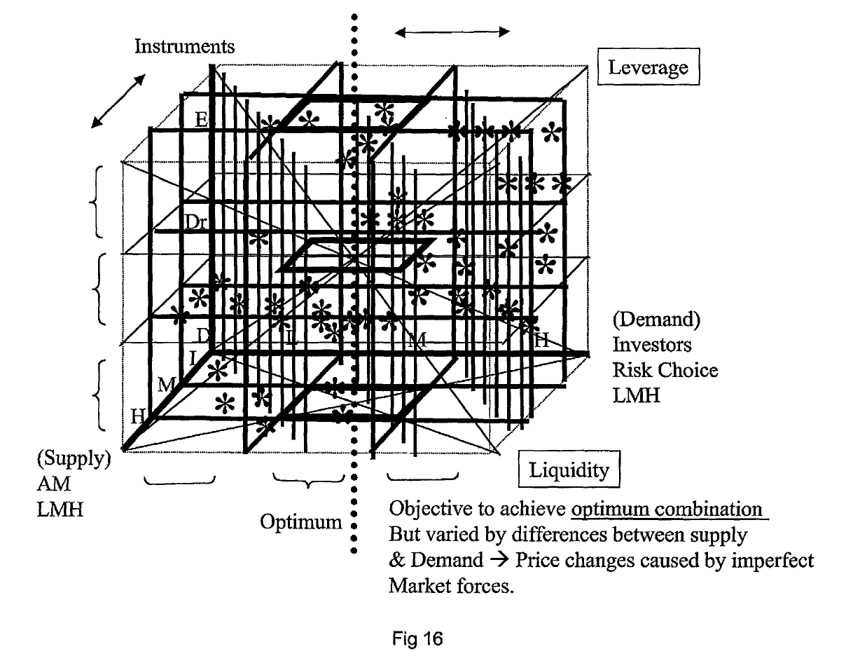

### A GLOBAL PROBLEM THAT IS HURTING GROWTH:

Recent capital market fluctuations in the industrialized world are the result of both investors' perception of where the global economies may be heading as well as industries' reaction to the unplanned “new economy” that may have grown too quickly without appropriate investment management processes to direct it.

It is ironic that just five years back technology was developing into the darlings of both industrializing and industrialized countries where talents and products of technology were seen to direct the future economies. However, the investing market turned against the rapid growth so suddenly. Maybe it is because the bulk of the population cannot yet accept the rapid changing business landscape being eventually “controlled” by software or that they were just ignorant. The situation worsens and this could have been created by inappropriate financial support facilities between borrowers, lenders and investors to meet the fast changing dynamics of the Growth industrial developments and also to have an effective management process that may complement the new paradigm shifts.

What appears to have caused the reversal may have been the result of inappropriate capital “architectures” in support of the fast growing new economies. This inevitably affects managements' planning and company Boards' policies formulation. Alliance has been mentioned far too often with credits given just to Mergers and Acquisitions activities. Unfortunately, many of the deals result in “reactive” management strategies growing out of inevitable corporate restructuring exercises. Operational and strategic fits may have been considered, but often enough, “financial fit” had been taken for granted to be part of an alliance, which is reflected just through operation. This assumption could lead to mismatch of Investors ‘interests in relation to alliances’ needs. This may inevitably affect mid term growth enhancement of alliances since many mergers and acquisition activities eventually end up with debt for the dominant entity with the other sorting “financial convergence” with the hope to stabilize divergence among financial elements.

Eventually with the mismatch, there is a need to consider the creation of an “Investment portfolio” product that can both encourage and raise investment sources to appropriately allocate financial resources to “Growth” companies under alliance arrangements. Also, the proposed method of managing the investment portfolio must also be able to diagnose “live” the iterative nature of select financial dynamics reflecting the conditions of the investment portfolio as it grows.

Supporting the Claim of the Problem Came from Research, Along with the Establishment of:

“Alliance Capital Structure Sustainability Index” (AFSSI)

This is an Index created by this inventor to assess whether “Growth to Maintenance of a business cycle” phase for “Growth” industries in the South East Asian region after the 1997 Asian financial crisis were adequately and appropriately funded under various existing capital structural combinations of Debt, Equities and Convertibles for companies involved through “Tight” alliances arrangements.

Results from Research Conducted:

Data collected were from the four South East Asian countries, Thailand, Malaysia, Singapore and Indonesia. 500 sets of Research Questionnaire was sent out in 2000 to four South East Asian Countries; Thailand, Malaysia, Singapore and Indonesia. (Data received from Indonesia was taken out from the analysis on account of many inconsistencies found)

The Survey took into consideration the general economic condition from 1997 to 2000, markets operating within the categories of “Growth to Maintenance” phases in different “Growth” category industries, and the liquidity status of average number of companies within respective countries surveyed of an established time frame.

Included in the surveys were Medium sized companies (defined as those entities whose shares were not listed on any Exchanges in the stated region under survey or entities being a part of any listed vehicle) operating under various alliance arranged and non-aligned companies. Mergers and Acquisitions activities as part of alliance arrangements between publicly listed companies in the region were not included in the surveys.

AFSSI model assessed several key select financial and economics variables, which this author believes are, of a focused manner and they would impact the dynamic nature of Alliance Capital Structure decision-making processes. Findings are categorized into the following seven categories.

Available Financial Facilitory systems available for Alliance Growth Industries in the region:

2.85 out of 7.00 (or 55% in agreement)

Available “appropriate” Debt Financing Facilities for Alliance Growth Industries:

2.85 out of 7.00 (52.3%)

Available Equity Financing Facility for Affiance Growth Industries:

4.45 out of 7.00

Institutional capability to provide appropriate mid to long term financial strategies to encourage alliance Growth within Industries:

3.85 out of 7.00

Institutional Capacity and Stewardship in Funding of Alliances between enterprises:

4.55 out of 7.00

Overseas Investors' understanding of Regional Alliance Funding Need:

4.25 out of 7.00

Would Alliance Growth better served through a dedicated Investment Fund that effectively channel needed funds to alliances through appropriate financial instrument architecture:

5.85 out of 7.00

The data generated from differentiated Debt and Equity financing facilities for Alliance Growth within the countries surveyed during the period were put through relevant systematic statistical testing procedures to highlight their respective effects on select financial variables to see if “Alliance Investment Portfolio” (AIP), when created as a specialized Funding source, could propel economic growth in High Tech industries.

Multiple Regressions and Factorial analysis were also applied accordingly to identify select variables needed to examine probable alliance mix considerations. Sensitivity analysis from the impact of possible hike in interest cost on risk profile to an AIP was also conducted, and relevance of the findings demonstrated that correlation factors between interest concern to risk perception, risk's impact on investors' expectation of investment return, and range of financial instruments. The result was positive. These exercises were conducted to see their respective impacts on inter-factorial relationship through a proposed alliance investment management process. The various procedures worked through the process established the proposed system to be particularly useful for phase II of the AIM methodology mentioned in this presentation.

Future financing in the region's High Growth Industries lie not just in financial intermediaries' ability to co-ordinate an Investment Portfolio suitable for Alliance activities, a diagnostic system that allows the iterative nature of situations to be reflected “Live” would be a significant contribution to technology supporting financial management. The proposed method and system of simulation under a multi-dimensional structure allows this to happen through an implemented software procedure.

The challenges in corporate finance management for alliances appear to be that of achieving an “optimal capital structure” that can facilitate the needs of Growth industries while continuously creating investor's interest through containment of risk fluctuations while achieving expected Return targets to match range of risk undertaken. Such interactions could produce equilibrium and establish equitable pricing for an alliance investment product. This process would involve not just an Alliance Investment Portfolio Specialist's ability to not only understand the intricacies involved through the financial aspects of creating and managing an appropriate portfolio of alliance businesses but also his ability to understand and create economic values of various “portfolio assets of alliances investment”.

Proposed Solution to the Problem as Perceived:

The earlier research conducted which supported the argument for a solution to the “problem”. A multidimensional method and system that both simulate and manage an Alliance Investment Portfolio (AIP) process is thus introduced.

The methodology process begins with the rationalization and creation of “select alliances” to become the asset of the investment portfolio. Together with other available existing alliances meeting the stringent criteria established by the AIP, Combined “Alliance mix” under nine different financial variations that can response between the iterative nature of investment dynamics, through a 3×3 matrix incorporating leverage and liquidity functional relationships, would be established responding to Investors' interest thus appropriately allocating financial resources to these alliances mix to fuel their growth.

This Inventor's Perspectives: Evolutionary Alliance Investment Portfolio or AIP Through its Management Dynamics (AIM or Alliance Investment Management)

The proposed product management method and system of diagnostic also serves as a strategic corporate finance management “visual reference tool”. It grew out of several years of research and consulting work aimed at translating corporate finance management strategies into a disciplined methodology to assist in the development and implementation of alliance corporate finance, focused at investment portfolios for practicing financial managers and corporate planners.

Investment Management is an old and established profession. Portfolio Investment simulation systems via iterative processes to facilitate portfolio investment management processes have, in the pasts two decades, grown in sophistication thanks to the development of computer added diagnostics

The proposed financial diagnostic and simulation systems will also be able to assist an alliance portfolio investment process with both the:

1. “Evaluation and establishment of financial and economic merits” within an Alliance Investment Portfolio (AIP), on a “live” basis when executed through a separate software composition, and to also

2. “Assess and establish the AIP valuation against both market demand (from Investors perspectives) and supply (Growth of the AIP via Alliance Mix combinations) dynamics via the iterative nature of portfolio management processes.

The multi-dimensional method and system proposed here is hence to simulate and diagnose functional financial relationships within an Alliance Investment Portfolio dynamics. It is structured as a “Visual Reference diagnostic tool”, dedicated to facilitating an Alliance Investment portfolio Management program, both on-line and offline. The methodology provides both Investors and Specialists (Lund Managers of an AIP) alike with visual diagnostic with analytical capabilities. Such a system is structured scientific in approach and requires both quantitative and qualitative judgments within financial frameworks throughout the system's three-phase methodology. The entire simulation process thus enable “transparency” to both the investing public and the users of finds sourced.

The proposed method and system grew out of Research by this author through earlier consulting work and with relevant literature support and references from theoretical foundations. Simulating an alliance investment portfolio management diagnostic process through such a disciplined methodology requires the persistence in continuous research on selecting key financial variables to be applied where applicable. The methodology does not sit as static diagnostic. It is dynamic. Hence it has the ability to be applied “live”.

The Perspectives of this methodology, as well as the diagnostics associated and applied within, is therefore aimed at assisting alliance investment consultants with a more effective strategic thinking and planning thought process throughout the hierarchical and functional levels involved in the complex alliance investments portfolio activities. As such, alliance portfolio investment consultants and Alliance fund managers will have to be able to adjust their mind set when applying their planning processes to meet the iterative nature of alliances formed.

Tools and Definitions

Tools:

Tools involve progressive strategic thinking of corporate finance fundamentals and the understanding of financial management. Both quantitative and qualitative analysis and sensitivity analysis play important roles in the developments of Alliance mixes. However, the degree of complexity of the financial management dynamics has been simplified here through the appropriate application of economics and financial inter-relational understandings. Important functional relationship here involves the selective application of financial management procedures modified to substantiate alliances dynamics played through “financial fit” consideration.

Key Definitions for the AIP:

Tight Alliance Structure:

A situation between enterprises is defined here to be of a collaborative and cooperative venture, where there is a successful union of two or more corporate organization, under a mutually respected, custom created alliance architecture, where there is technology exchange between parties involved, through tight economic cooperation and arrangements, continuously adopting new forms to generate economic values. This process is supported with both financial and Real Investments of Capital.

Strategically Formed Alliance:

Exists when business relationships, through a “tight” structure, allows continuous transfer of technologies that benefits not just shareholders, but also the relationship that generates efficient and effective economic flows to meet the Growth objectives through the entity's operational and strategic, chemistry and “financial fits”.

“Alliance” Investment Portfolio:

Such an investment portfolio exists out of strategically formed alliances. It incorporates “financial fit” as the required fourth dimension in a strategically formed business relationship.

Financial Fit:

Exits when there is “synergies between capital structures” of select alliances within an alliance investment portfolio. The economic values of “synergies” here rests in correlated supportive financial elements that establish appropriate capital architectures that reduces alliances' cost of capital while iteratively meeting liquidity and leverage functional responses through an interrelated AIP management process which also copies alliance mix combinations.

Alliance Mix Combinations:

Exists through nine different independent combinations of capital architectures.

Each combination is reflected through a “cell” in an AIP 3×3 matrix platform. Alliances within an Alliance Mix are divided in a four-quadrant form and are statistically measured and positioned.

Alliance Investment Management (AIM):

The management process of simulating the dynamics of AIP through a 3×3 matrix platform. The methodology is in a three-phase procedure beginning with the diagnostic process of alliance creation. It then proceeds to create alliance mix before it goes to the third phase where integration of AIP and AM comes into play with AIM's process in managing the demand and supply of AIP investment instruments, development (Growth) of AM and its congruence with AIP's investors' risk profile and expected return. The process achieves optimality that creates value in both alliances and in AIP. AIM has separate processes of analysis via its own 2×2 Matrix of diagnostic between select financials to risk, and to Growth relationship within an AM.

The AIM Methodology at Work (The Three Phases):

The AIP management methodology process (AIM) consists of three phases. Each phase has its distinct characteristic justifying their particular function and contribution within an AIP.

Technical drawings attached are presented in three-dimensional form and are explained visually with footnotes provided.

It must be noted that the entire AIM process is iterative in nature. It is performance oriented and it “reacts” to situations. Case situations are presented here to demonstrate the dynamics of the AIP within the confine of AIM in phase III of the methodology where they demonstrate the effect, or result of; (through drawings accompanying this submission) the following broad interactions:

Change in Investors' choice for AIP through four choices,

Change in Alliance Mix (AM) combinations

The drawings attached also highlight the positioning of alliance within an alliance theater (or Cells). There are all together nine cells carrying nine different characteristics of financial considerations, nine different level of risk composition with nine different degrees and combinations of Alliance Equity, Alliance Convertibles and Alliance Debt instruments within an AIP 3×3 matrix platform.

The incorporation of the “Leverage and Liquidity curves” are particularly significant in this methodology as the “difference” between these two key financial barometers affect the price of the AIP and also impact on Investors' perception of the viability of the AIP at a particular point in time (when measured Live). The significance of the differences between these two elements also reflects the “trading range” of the price of an AIP. Hence, its ability to raise capital to continuously fund the alliance mixes.

The architecture of the AIP platform consists of nine “Cells” where size of that platform establishes the size of the AIP. A vertical pole through Cell 5 in the 3×3 matrix is the “price indicator” in reference to Earnings generated from the AIP's valuation process. Each cell carries with it alliances and they are positioned within a four quadrant plotted according to their economic standing relative to each other. Covariance of alliance within each alliance mix is also established. The depth of each cell box below the AIP matrix platform represents the amount of investment the AIP has injected into the cell.

Phase I

(The Rationalization and Formation of Alliance Stage)

Objective

The Objective of the First phase deals with the “Search”, “Rationalization” and “Formation” processes from appropriate “Target” companies to forming Alliances out of them. Existing Alliances would also be considered as a part of an “Alliance Mix” in an AIP but their merits would have to be tested at this phase also.

Apart from the normal analysis conducted on the Operational aspect of a target's business, in-depth focused financial analysis of each targeted entities is carried out on such select “Targets”.

Targets considered for an AIP is not restricted to any particular industry or to any particular market. Targets to be considered would have to fall within the investment criteria framework set by the AIP. Also, Targets would have to be able to fit into nine different “Alliance Mix's” Capital structure architectures established within AIP's investment policy, constraints and guidelines. Any proposed Alliance's “Capital Structure” as such must be established within an Alliance Capital Architecture that is formed within set parameters of financial and economic relationships determined by their qualification of fundamentals to fit into one of the Nine cells.

The “Search and Rationalization” Process:

“Investment opportunities approach” is a part of the Alliance Investment management or AIM process.

Because of the need for continuous supply of Alliances to grow the AIP, the search process is an on-going activity so that the “continuous supply” of formed alliances can maintain an Optimal AIP's portfolio size. This is an important focus in managing such a portfolio. AIP with a less than appropriate size relative to portfolio and the sum invested inevitably all increases risk and thereby affecting its valuation.

An over-sized, inappropriately structured Alliance Investment portfolio would skew Alliance Mix compositions either towards too much equity or too much Debt instruments thereby reflecting less than favorable valuation by the investing markets. An AIP's “Harvest” or “Divestment” process of any part of its Portfolio's assets inevitably affect both the AIP's value and the relationship between its capital structure to the Alliance Needs, as reflected through the portfolio's liquidity position. As such, continuous search for new alliance opportunities protect the interest of existing Investors and maintains portfolio's dynamics within an optimal and manageable platform.

Evaluating Select Targets for a possible alliance relationship begins with:

Generating and evaluating Options (target entities) available,

Acknowledging Targets' corporate values among expectation and Objectives, (seeking Strategic fits)

Recognize targets' Resources available, (seeking Operational fits) and

Examining Targets' current organization structure, (seeking people and system that can integrate and or converge at lowest cost).

Incorporating these variables through strategic analysis where qualitative judgments are applied together with supportive quantitative analysis of financial data can provide “parameters” support to determine whether select Targets' objectives can be achieved through an alliance arrangement.

The key here is to discover Alliance's Fits: Operational, Strategic and Chemistry between targets. This process rests heavy on assessing strategic effectiveness and strategic efficiency of each Target's merits to a proposed Alliance arrangement. It also simulates possible Alliance Mix outcomes scenarios.

Significant in this phase is the determination and the establishment of possible “Financial Fit” between Alliance partners also. This rests on Capital Structures that are towards “what it would be” when they are restructured. The effects from Gearing for Growth are not viewed as independent process now but are dependent on each alliance partner simultaneous responses and the combined impact is reflected through alliances' operational considerations within an AIP. More importantly in the consideration is the process to maintain financial fit that enhances Growth for the Alliances within the AIP.

Assessment of “Strategic Efficiency”

The AIP's Efficiency factor concerns basically test with the relevant financial ratios of “outputs generated from Inputs” frameworks by proposed Alliances in their combined activities. The Efficiency issue measures proposed Alliance's projected Return on Investment, its Profitability from Sales and its production. These are assessed through understanding at each Target's level the following, and “Factored” to them consideration that provide levels of concern ratings for use later in the diagnostic:

Profitability factors: Financial concern measures the utilization of specific resources to overall objectives. How and what measures applied are key concerns here. Seeking “convergence of Resource utilization” enhance management performance between proposed Targets in an alliance is focused. Simulations of “combined” financials (e.g. stock turnover, R&D process, Debtors/Creditors turnovers) are applied. The objective is to seek a level playing field for the Sponsors to come in and to establish an entry price for investment considerations.

Labor Productivity: Seeking “value Added” processes. How is the relationship between Targets' management and staff? How will their corporate philosophy affect another Target? The findings can affect labor productivity. It is necessary to measure efficiency of human resource, and combines assessment of both efficiency and effectiveness leading to productivity performance on an alliance scenario. It is the really the measurement of combined productivity.

Yield: the measurement in efficiency from cost competitiveness when alliance is formed. Sometime, competitiveness within a proposed alliance may instead be negatively affected.

Capacity: Not just in physical capacity to house operations, but also into Intellectual properties in service industries where no additional cost is needed to satisfy customers. Seek and understand alliances' strategy and their abilities to survive as “one”.

Working Capital: Assess how well each Target copes with achieving appropriate balances at times where operating above or below working Capital constraints. Recognize how each handles the risks associated with situations and see the “fit” between Targets on Operational managements. This signifies management skills of working capital management on an alliance platform.

Production System: Understand job designs and see if alliance could cause other problems instead. Not every alliance can work well under a particular production system. Situations where Targets complement each other may be a plus, but competitive advantage from one may adversely affect another. This calls for the Specialist's ability to recognize failure “signal” and to also comprehend operational differences between Targets. The distinction here between the AIP, through AIM, from other Portfolio management process is that AIM recognizes each alliance at the formation stage to recognize the detailed production system and to ensure complementary support for one another. Though the AIP also includes alliances already formed for the portfolio, the due diligence process incorporated at this stage of the affair ensure that “an alliance already in place” can stand up to the various qualities and constraints tests also.

Strategic Effectiveness:

The process of understanding each Alliance's manner and use of resources require the analysis of the effectiveness with which resources (both human and non-human) are designed for a specific purpose and applied from different measurement methods of effectiveness. What the Specialist would be concerned with is on “Strategic Effectiveness” of alliances through an Alliance financial structure (or financial fit), assessing the sustainability of its competitive advantage in the form that benefits the combined performance relationships.

In quantifiable manner, strategic effectiveness of alliance can be measured through statistical “degrees” of differentials from which their combined interest and performance can achieve the Goals set and agreed upon between alliance partners through an AIP. Effectiveness of the alliance is thus measured through the combined efforts reflected in the Market valuation, Sales Growth and the quality performance from Investors' expected Return in an AIP.

Consideration of Strategic Effectiveness evolves around:

Appropriate utilization of Human Resource. This is measured by Staffs economic contribution. When staff is assigned to work in unskilled situation, their performance affects both the morale and the entity. Concern of Nepotism is always present in an alliance.

Appropriate utilization of Capital. Here, we examine the company's long term funding strategies. Do Targets mismatch their fund utilization: e.g. using short-term credit facilities to finance long-term projects? Often, analysis of capital structure would uncover Target's attitude towards gearing. Compare the Target's practice to market practice. This process discovers their profitability potential.

Use of marketing and distribution resources. Seek synergies in operation and assess combined sales force performance through simulation process. See how each Target's approach has been to execution of marketing strategies and identify areas of complementary opportunities.

How has Previous Research and Development Fund been utilized. (Situation if specific project calls for an alliance)

Assess each Target's control arrangements on R& D finds. Though it may not be able to quantify the effects of earlier resource used on R& D, the Specialist should instead assess the management procedures to establish the “control” mechanism in allocation of Fund for use. Seek reports on past successes.

Next, to evaluate the R&D, the Specialist needs to determine whether the selection of R&D programs is integrated with a sound overall long-range plan and is based on market research findings.

Compare the nature and the depth of the combined R&D capability with the proposed situation. See if the future needs of the alliance can be improved with the integrated new product program.

Next is to compare cost to benefits from proposed projects. Look at where the alliance's proposed project would be in the product Life cycle curves in the industry. Composite plots can show trends in life expectancies and also indicate developing gaps. It is important not to just utilize past data from positions to project estimate for the future. The proposed alliance will be a different arrangement and therefore requires compatibility studies on product R&D and other considerations before financial structures for the alliance can be established.

Further to the above, key issues like the following have to be addressed:

What resources will the alliance require for its implementation of the objectives?

What extent will the required resources build on or change the existing resource situation?

Can the required resources be integrated with each entity through an alliance?

What are the priorities and key tasks of the alliance formed?

Are the assumptions used on the proposed plan is appropriate to the dynamics of the situation?

All these measures prospective alliance financial performances

Key Overall Evaluation Process

The overall evaluation of each Target can be narrowed down to the following key considerations:

Evaluating the product lines and targets' basic competitive position. Ask questions like if an alliance is formed, will the Targets market share be maintained or firmed up. Will the market react negatively to an alliance? Also, will each product line that does not complement each other strong enough to stand on their own feet? What will the future be like under the proposed arrangement?

R& D and Manufacturing facilities. Ask if combined arrangement is better off for R&D. How far can the Operational Fit really last? Is there going to be cost improvement and improved incremental benefits?

Financial management. How will the financial data trends look like after the alliance arrangement? What do the trend analysis tell the Specialist of the financial facts indicating the alliance's prospects for Growth. This is important; as this will set the basis for consideration under an Alliance Mix structure and eventually the impact on the AIP's value. Ask what sort of financial management program can steadily improve investment returns. How much does management understand the cost of their long-term objectives measured against short-term benefits? Is the management used to reacting to problems or are they pro-active? Find out if management has the respect of the financial community?

Top Management. Identify the strength, weaknesses of the Targets' top management. Look into the characteristics of the Targets' management and understand their operating philosophy. How will they handle crisis? How management from Targets can work together?

Board of Directors. What is their mandate like? How capable are the Board members in handling shareholders' request? Will the alliance cause Board members from different Targets to create different motivations? How do they evaluate business strategies?

Apart from the key issues above, the rationalization process to support decision of alliance fit has to do with:

Recognizing problems areas, knowing a state of affair that exists and see how an alliance can assists.

Problem diagnosis; define the problem, seek information to identify specifics and narrow down to possible adverse effects if an alliance is formed.

The next step would be to seek “appropriate alternatives” through proposed alliance relationships. The point here is to recognize if independent Target's management move their organization before they are forced to react or are they reacting to environmental pressure. This will partially establish their strategic “Fit” considerations for an alliance under the AIP. Recognize the management's multiple contingency plans rather than relying on just one single plan. This is useful for the Formation process.

The diagnostic process would have required Specialists to set out a “Table” highlighting their findings and ranging them in sequence of priority match and to seek priorities variables for consideration. The Table would have defined each Target's objectives and assign Factors to them for weight and summing those weights would assign priorities for alliance consideration. Such a Table will be useful for later Alliance Mix considerations as the various key variables analyzed would either add weight or cause the Specialists to have lesser interest of a particular situation.

Financial Analysis as “Resource Analysis”:

This is significant at all stages of resource analysis of an alliance formed. The findings form part of a database for an Alliance Mix consideration to be used in later stages. Often enough, forecasting of cash requirements and liquidity cycles for stated objective and other related activities that are considered in a proposed alliance appear to be most crucial.

The AIM's diagnostic process requires important consideration of the Targets' combined resource under an alliance arrangement. The Specialist must look at both targets' resources: both financial and non-financial. The Specialist must also ensure that a balanced approach be looked at carefully at this stage to see if each Target's current economic condition is suitable for an “Alliance Mix” for it is through that process that investment Funds would be generated for use at an alliance considered. The diagnostic here is to assess the liquidity needs for the period of the project. Looking into each target's contribution at both financial and non-financial level determines a “need” for a capital structure. This process establishes the financial conditions and reflects the proportion of Equity to Debt, effectively looking into the capacity of an alliance to address a proposed comfortable Debt level. This stage of the diagnostic provides only an “alliance Liquidity Need”, generated from detailed cash Flow projections from each Target and from the proposed alliance arrangements.

Important consideration for AIM process is to ensure stability in “Operational needs” for the alliance. This therefore sets the parameters of cash requirements over an expected period of time under arrangement. The emphasis here must be in recognizing and prioritizing needs at the alliance level. Failure to provide this diagnostic will de-stabilize the Alliance Mix in the later stage of the entire process.

The mechanics involved at this stage is technically a Working Capital Management process but the important note is that AIM caters for the need of an “alliance” situation. Each Target, through an alliance agreement, may have clauses that require funding flowing into Target's other related operations. Such situations do exist and the Specialist must be able to offer a flexible approach to seeing to this need. As such, the Working Capital Diagnostic process must:

Establish credit limit policy to the alliance and its other related operations from AIP sponsors.

Establish Guidelines on Net Worth and Net Working Capital parameters. (To ensure that credit limit is within allowed percentage of Net worth or of another percentage of Net Working capital.

Establish Liquidity Test through a “Liquidity profile” from Current Ratio, Acid Test, Accounts Receivables and Inventory Turnovers.

Establish Profitability Test through projected financials (Profit margin, ROI, ROE) based on information collected through the Formation stage of alliances.

Establish Liquidation Coverage. This procedure (each alliance determine its own liquidation percentage) effectively put the alliance on “Notice” that failure of the alliance to perform within set parameters to generate the expected return would throw an AIP off tangent, and that may force the AIP to “divest” an alliance from an Alliance Mix for cash within a pre-set quadrant in an AIP matrix platform. The liquidation percentage computations incorporate the Asset of an alliance entity, and apply appropriate weight on “most liquid to less liquid” assets and generate an assumed Realizable Value to each asset. Deducting away all liabilities will generate net liquidation value of an alliance entity.

SWOT Analysis

This is concentrated on individual Target. The purpose here is to establish a “Capability Profile” of a Target in respect of another Target and determine if that profile can fit another to form an Alliance.

Such a Profile is developed from meetings between Representatives and the AIP's Specialist. Data support made available would provide comfort to substantiate certain observations. This list is derived from Qualitative Process. Key issues to be considered are:

On Strength:

Establish if there are strong R&D and Marketing capabilities. On its own, could a Targeted entity stand on its own if an alliance cannot be formed on account of weakness in Chemistry Fit?

Does the Target have High-Quality Products now? How is that going to affect another Target's entity through an alliance?

Does the Target experience Market Leadership today? Will an Alliance help them achieve Market Leadership soon? Will there be spill-over effects on the other partners?

On Weaknesses:

Were there frequent Management changes at the Operational levels?

How did a Target handle situations of “Too much” production capacity? Would the practice, if applied in an Alliance situation, create “irresponsible” attitude for others?

Has a Target over concentrated on a few Products? How will those products affect an Alliance partner?

What strategic management approaches does a Target take in handling unexpected situations? Would such strategic approaches be a “plus” to a proposed Alliance?

On Opportunities:

Could an Alliance arrangement maintain market leadership for Target? Would there be spillover effect to other partners in the Alliance?

How would new innovations from one Target, funded by AIP affect, affect the proposed Alliance? Particularly, how would new innovation from one Target affect its partners in an Alliance?

Strategic Growth consideration. How would the Target's move towards and alliance either via Vertical or Horizontal integration be beneficial to its Parents (assumed that this is a Subsidiary of another entity)? Will a proposed move affect the market as a result of such an Alliance, be it with another competitor?

How would a Target's improved financial position, after an Alliance is formed, assist in the Alliance's future Growth? How would that affect the other Targets within the Alliance?

Would a Target's proposed “Diversification” approach through Alliance structure be of short-term benefits?

On Threats:

Will an Alliance saturate the market for a Target's product instead?

Will Partners resolve Technological problems or would an Alliance cause further problems? How do targets plan to resolve problems? Any additional opportunity cost like internal resistance that may affect an Alliance relationship?

Would there be internal resistance to change in Operational Management? How does each Target's middle management view of a proposed Alliance with competitor?

Such a profile effectively lead the Specialist to consider if an Alliance would be vulnerable at time of indecisions between Alliance partners.

Vulnerability Analysis

Such an analysis for a proposed Alliance is vital. This is a conservative assessment of possible “downside” risk. Effectively, it asks the questions:

“Is the proposed Alliance just to fend off on-coming strategic weakness?”

“What if supportive elements, from other Targets in a proposed Alliance, were taken away?”

“If Targets decide to break away, would such an action adversely affect the other Targets in an Alliance? How long would recovery take?”

The Vulnerability analysis can be reflected in a Chart describing assumed situations with possible consequence. These are then “Factored” to reflect the “probability” of the situation occurring, the capability of a proposed Alliance Management to handle it. An assessment of the “Vulnerability Impact Rate” would also be registered.

With the data developed, a Vulnerability “Assessment Matrix” relating between “Alliance's ability to react” and “Degree of Impact on Alliance” could then be drawn up.

2×2 Matrix charts the probability factors on “severity of probable concerns” (e.g. loss of suppliers because of the formed alliance, loss of corporate identity resulting with loss of customers, loss of cheaper source of supplies as a result of the alliance formed) and reflects each concern as a position between “High to Low” levels. Concern would be those issues at “High” levels. The findings can have an impact on the Specialist's recommendation for a particular Target to be considered to be a part of an Alliance composition.

Formation Process

The important variable constantly evolving around the Formation dynamics has to do with clearly and consistently defining the purpose of why Targets consider an alliance. The qualitative judgment is a function of not just the Specialist's understanding of the circumstances surrounding the rationalization process but from the deep understanding of the “combined” strength, weakness, opportunities and Threats analysis. This is also the foundation to an Alliance Mix for the AIP.

The most effective strategic approach for the Specialist would emerge from step by step iterative process in which the Specialist probes the future, the proposed project and examine claims of incremental performance committed by staff and Board's commitment.

The Specialist needs to also consciously intervene in situations from the Target Rationalization stage of an alliance consideration. The Specialist must improve the information source made available for decisions by the Executive committee and to build psychological bridges between the Targets and the Sponsors. This comes about from updating their findings along the way through the rationalization phase. It is important that both logical and incremental approaches be used. Describing possible situations through Scenarios is a simple and direct approach under such circumstances. This is particularly useful when scenarios are painted with supporting data that can be used for later sensitivity analysis when it comes to correlating specific key financial variables to Macroeconomics issues like market conditions, GDP and cost of finds.

Being proactive and purposeful is vital in the Specialist's approach at the Formation phase of an alliance. The Specialist must demonstrate confidence and must dare to execute the proposal under consideration to establish confidence in an alliance project. Targets often look to the Sponsors through an alliance as the “endorser” of a proposed deal.

Ultimately, the feasibility of an alliance requires both internal resource management capability (that includes financial) and internal political acceptability. The formation stage of an alliance therefore requires that the Executive Committee (Policy) of an AIP be prepared to continuously adjust the mindset of Targets to the criteria set for the “financial fit” considerations and to also advocate changing and influencing a proposed alliance organization.

Often enough, Targets want to see quick results through an alliance and a compromise of possible major shifts in corporate direction can be compensated if the alliance sponsor can give them the comfort. The committee therefore must recognize that and seek incremental adjustments in assessing each alliance possibility.

For the success of a proposed alliance, the system of analysis at the Formation stage must be flexible to be able to add functional relationship considerations influencing the dynamics along the way. The inappropriate use of basic quantitative approaches through statistical procedures often provides data that may be out of date when needed. It is therefore important that the Specialist uses “iterative” process where communication is frequently through face to face or through the use of telephones. The ability to interact between key players of each Target with the Specialist is very important. It not only provides confidence building, it also establishes strategic approaches where targeted parties can work “from the beginning” to the establishment of “Chemistry Fit”. From there, parties seek alternatives and select appropriate remedies for difficult situations under consideration. This process often involves Specialists' qualitative judgments and their attitude towards the business and operational risks of both entities concerned.

The Formation Process must establish the following key considerations:

Evaluate “Chemistry” between potential partners.

Clarify “Parent-Child” relationship (those whose parents who have specific strategic intent and objectives) with potential business alliance partners.

Establish Role of the proposed alliance.

Propose business, operational and strategic framework. At this point in time, Financial Fit would have been worked into an alliance equation.

Negotiation on “Exit” provision in the event Alliance fail to meet expectation.

Prepare “Letter of Intent” to form alliance between potential partners, led by AIP Specialists.

As such, this phase is to establish the set of pragmatic requirements developed at an alliance level from Targets considered. Principal inputs are the vision of the firms, the environment scan and the scrutiny at both Target and proposed alliance levels.

Before moving on to the next phase, corporate performance objectives of the proposed alliance are to be established. Financial Fit has to be established with the fundamentals;

Growth Rate,

Profit ratios (Gross margin, ROE),

R & D expenditure plan,

Debt to Equity Ratio and

Dividend payout.

The above must be made with reference to Targets' abilities and that is made in reference of their past performance. Proposed Alliances have to be established within the formulation of their proposed business strategies and proposed execution plan. Their proposed functional strategies made in reference to operational and strategic fit in the proposed alliance.

To achieve financial fit, the AIP must be able to “balance” the needs of proposed alliance's portfolio. This is crucial as AIP spans several dimensions of concern. AIP has to look at alliance from both short-term profitability and long term ones. This involves also the establishment of the identification of opportunities cost between risk and return; in association with AIP's constraints.

Financial fit calls for the balance between Targets' liquidity at leverage at the proposed Alliance level. This process seeks to establish a possible equilibrium of source and use of proposed funds and to establish optimal balanced “Alliance Mix” at the next phase of the methodology. A 2×2 alliance matrix correlating the difference between the strength and weakness of the Financial fit (resulting with a factor), in relation to AIP's capital structure constraints (Factor) would provide a guide to the specialist in identifying and providing basis for possible financial engineering maneuvers to also achieve weighted average optimality within proposed Alliance Mix for appropriate balanced capital portfolio structure in AIP. This stage of the process is crucial as failure to establish an equitable state between Targets' objectives would have made a proposed alliance a failure technically for consideration within an AIP's alliance mix combination. Since there are altogether nine combinations within an AIP, categorizing each proposal at different degrees of comfort is left to the next phase of the entire methodology.

Phase II

(The Formation of Alliance Mix combinations)

Objectve:

The objective here is to build and establish nine Alliance Mix Combinations to fit a nine cell architectural platform of an AIP 3×3 matrix.

After alliances have been proposed from phase I of the methodology, this phase of the process begins with “categorizing” each proposed situation through the final Financial Fit test process and consideration, via key select financial elements.

The composition of the financial fit at this juncture must ensure that there would be no conflicts between parties involved. Recognizing the proposed alliance needs is through the process both in establishing “match” with the availability of find source for a particular alliance considered. The financial fit sees to proposed alliances within the AIP's framework of debt to Growth potential. Next is the cash flow support to ensure that financial investment is available for Real investment to the proposed alliance. Working capital “adjustments process” is not from the need side alone but to enable a balance of availability to need. Forecast of profit and needs are compared to business practice and industries to establish range of performance to justify investments.

Since data source of differentials between elements from proposed alliance had been established in earlier phase, what this phase does is to optimize “prospect to risk, return expected by investors and for appropriate instruments in both investors” portfolio and that of the alliance mix (AM) within an AIP.

New debt issues and new equity issues in relation to interest payment and dividend payout are determined based on earning forecast but these numbers would have to be adjusted to fit the strategic funding process of the AIP. Bearing in mind that a significant play of an AIP as a visual reference tool is its ability to integrate “Live” leverage and Liquidity functional relationships to establish variance from prospective earnings, and reflect against actual earning performance. The ability to provide such iterative responses ignites the transparency capabilities of the AIP simulation system.

The AIM process at this stage of the diagnostic addresses the question of “abilities of Sustainable Growth” within an Alliance proposed. This is as good as measuring and computing variance between select financial “factors” from and integrating elements within; for instance, ROE and ROCE, to support Alliance Mixes' continuous inter-relational support and from these variables differences be analyzed and resulting correlations findings be adjusted to each alliance's internal “resource tolerance” levels as well as their ability to continuously raise debt to fuel Growth within an alliance consideration. Cost of Fund, or “market interest rate” used here, is the moderator as such to play the critical role with respect to Cash flow and to Debt creation.

The approximation process to ascertain sustainable growth level, with respect to both current equity and future position, is based on derivation from return differences to be expected from an alliance expansion within an AM situation. This is a function of both what AIP can support (within its financial standing through market valuation) and what AM can contribute to AIP in bringing out favorable ROE in respond to other investment portfolios opportunities that prospective investors to AIP would consider.

This phase of the methodology also preliminarily evaluates proposed alliance programs and assigns priorities for resource allocation within an AIP to various AMs. The diagnostic process considers the assessment of the affordable growth return to total funds available and the choice is divided between the nine different “Cells” within the AIP's platforms. The assignment of priorities to be given to each AM is both a science and an art. More science if one appreciates the quantitative analysis that goes into the appreciation of the microeconomics of each alliance in respect to their proposed programs. In the process, proposed alliances are put through sensitivity analysis referencing key financial elements (profitability, Growth rate, ROCE and Dividend Payout ratio) with respect to weighted average Risk factors that are within the defined variance (constraints) of Investors' choice to an AIP. The fundamental measurement in the sensitivity analysis is to identify the Risk factors that may “prohibit” alliances from achieving their original objectives. That is to say, even with those four key financial elements in consideration, the purpose is to see the reaction to adversities from risk of the market.

The other quantitative approach is the derivation of factors that encourages Growth, or motivator for Growth within a range of “degrees”. Each degree corresponds to the perceived risk to return expected by investors within an AIP. Making a match is the function here. From this angle, key financial elements considered are: Liquidity, ROE, ROA and Gearing potentials to be measured against Growth projected within established guideline of risk return relationship.

The eight elements having been quantitatively analyzed provide the “parameters of tolerance” of each alliance to be considered for the alliance mix. This, within an AIP's constraints would allow each alliance the opportunity to establish itself within respective “locations” of a 2×2 comparative matrix within the cell proposed.

The Art of the process is seen through “live” iterative process through the “Ball in the Prism” maneuvers. Descriptively put, each Ball, representing an alliance with the already positioned key financial qualifications, “bounces” off the four sided prism from the “risk” as the first phase, to “Return Expected” on the second bounce, through the “Proposed Investment Instrument” on the last bounce. The logical process is that the iterative nature and the earlier categorization procedure would have placed each alliance through the Ball as the “vehicle” to achieve a combination with Investment Instrument appropriately recommended considering the respective risk to return relationship. Within the prism is the moderator: Interest cost.

The second phase of the AIM methodology allows for realistic AM program to be recognized in the AIP through correlating to Investors' choice. This effectively means that Investors would be prepared to invest in a consideration if their investment criteria could be met, within acceptable variance, thus allowing for funds to flow to an AM combinations within the realm of the exogenous factor, which is the cost of fund. If the cost of find were high, that risk return expectation would have adjusted themselves within the constraints and accordingly address the resulting Investment Instrument combination for an Alliance Mix to change. Hence, the significance of “Mix” from the term Alliance Mix.

Technology allows the entire iterative process to evolve through software thereby providing a “visual reference tool”, another dimension in the AIM process. The realistic dynamics once generated, also respond to the necessary adjusted variations and degrees of change within the other earlier structured diagnostic of inter-functional relationships that generated the Ball. The natural responds is its maneuvers to the desired strategic direction within the nine AM of an AIP.

The 3×3 Matrix platform of an AIP has in itself “determinants” within its four quadrants (I, II, III and IV), dividing the varied Leverage and Liquidity degrees of functional relationships to the AIP's dynamics. Within each of the nine “cells” would also have established considerations of proposed Investment Instruments; Equity>Debt (in different degrees structured within cell #1, 2 and 4), Convertibles (in different degrees in cell # 3, #5 and # 7, and Debt>Equity (in different degrees in cell # 6, # 8 and #9). Each cell has its significance in terms of structural compositions responding to the different degrees of risk to expected returns. Corresponding to the differences in each cell would have the generated profitability performance, ROE and importantly, the effects from operating leverage to liquidity levels. Looking at “Live” will the “crossings” be appreciated.

For the 3×3 AIP Matrix to work effectively, it is important that each functional relationship within an AM is “aligned” in degrees and is “factored” within the boundaries of the eight key financial elements (that is not to say that qualitative judgment is not needed to adjust any differences). As we all know, there is no exact science in financial management process. Under different conditions where alliance are formed, variations can come about, but the AIM does have the mechanism to distribute the differences within the nine cells, thereby providing a “weighted average” responds. Such procedures avoid inherent ambiguities of the matrix form within a 3×3 AIP matrix platform. Because of the dynamic process, differences would have been averaged out within the constraints set.

The Matrix platform is then effectively an appropriate simulation platform for an AIP. The matrix here is an effective “organizational form” for an AIP also. But, it needs to be noted that the effectiveness of such architecture depends on resolving “situational characteristics” as reflected by each alliance at different point in time (dynamic nature) for consideration in an AM diagnostic process. A “check and balance” procedure supports the diagnostic process here through AIM and this would be evident where the eight key financial elements through the “Ball” are correlated. The final “posting” must still be within the constraints set at each one of the nine cells corresponding to AIP's overall restrictions. This is a structural issue because AM cannot change AIP's constraints, but AIP's constraints strongly influences AM's combinations. This can be seen in the next phase of the methodology when we see the interaction between Investors' choices to AM resulting with AIP's market valuation, which determines the funding strength to each AM's combination, flowing to each alliance ultimately.

As such, the critical success factors of a “Optimal” AM combination lies in AIM's abilities to correlate key select financial elements, in varying degrees, amongst the constraints set by AIP (finding process) through its risk to return profile, through the choice of appropriate investment instruments into the nine cells of the AIP platform. The quantified established support range from the “qualities” in each alliance proposed, reflected in varying degrees establishes the variance, hence, an alliance location within an AM combination.

Valuation process within the AM consideration would highlight the degrees of profitability contribution from alliance, profit margin on projects, risk recognition in relation to cost of capital exposure and more importantly, alliance performance to budget on the project. Deviations within an AM financial parameter would limit an Alliance Growth thereby reflecting AM's risk profile relative to the other different AM combinations.

The Second phase of the Methodology also keys in the strategic factors that involve the identification process of the critical success factors governing future profitability of alliances and alliance mix within an AIP. The diagnostic results in the assignment of appropriate weights depending on the inherent financial performances to the established characteristics of the AM against the AIP's investors' objective of the portfolio. The diagnostic process allows for the eventual establishment of weighted average performance of each alliance and the eventual AM. Select performance indicators, among the alliances within an AM combination would position each AM within the established AIP Investors' boundaries. Each cell therefore indirectly proposes the level of cash flow, ROA, AM valuation and strategic find availability at a point in time that coincides with the established value of AIP in respect to Investors' risk and corresponding expected return. Each cell as such receives different weights depending on the expected Growth in respect to the corresponding AMs. Hence, we have AM-High, AM-Medium and AM Low Growth potential. Corresponding to these is the level of Risks AIP's Investors perceived through: I-H, I-M and I-L range of choices.

Phase III

(The Implementation Process of the 3×3 Matrix Incorporating Leverage and Liquidity)

Objective:

Developing Equilibrium valuation levels of AIP through Investors' actions and AM Growth expectation. Establishing portfolio Optimality and provide appropriate combinations to AM through the AIP 3×3 matrix platform correlated with portfolio's impact from Liquidity and Leverage dynamics.

Process:

To recapitulate, Phase I established alliances for consideration into Alliance Mix (of nine categories) through diagnostics at each Target's level and simulated AM's Financial Fit.

Phase II expands the diagnostic of alliances proposed and put each one of them through the Prism testing procedures. Proposed Investment Instruments for each alliance structure, when put through the Alliance Mix combinations within established framework, would support financial fit established among alliances at each of the nine cells in an AIP platform. The congruence issue within each cell rest on the financial characteristics that can support and provide Growth potentials within sustainable level that is within financial parameters established by AIP's objectives and constraints. This phase strengthen the capital architectures that provide the nine variations that function within established constraints. Effectively, this phase of the AIM methodology establishes the Asset mix of the Alliance Investment portfolio. Proposed appropriate investment instrument for each alliance within the confine of AM combinations of the AIP nine-cell structure has also been established here.

Phase III is the execution of the fundamentals within the AIP platform; the interaction of Investors to that of AM. Investor's side provides the Funding while the users of the fund is, the nine AM combinations. The two functional relationships influence the equilibrium price of the AIP. Movements from Investors side create “Demand” for AIP equities or Debt instruments at three different groups of risk to return expected relationships. Each Group of the Investors' choice carries with it different degree of risk corresponding to different return equations with adjustments generated from market valuations of AIP. This is the “Trading Process”

Supplier to the AIP is the AM combination at each Group: AM-High, AM-Medium and AM-Low. Each Group of AM combination carries with them three different cells each with various combinations of Equity, Convertibles and Debt instruments for AIP investors.

Financial performances from each cell are reflected through the average values established by each AM combination. A weighted moving average can be reflected through “Live” situations when viewed of the 9 cells. Transactions between Investors and AM can be produced “Live”.

The strength in this 3×3 AIP Matrix, together with the meeting of the Leverage and Liquidity relationship, structured against the center “pole” provides a shape of a “Pyramid”. However, “Strategic” and “Financial” considerations (being key in the investment management decision process) within the AIP's dynamics is more significant when viewed through the characteristics of the “Four quadrants” on the AIP platform, and the “Diagonal Divisions” between “High and Low Leverage” and “Low and High Liquidity” corresponding to Investors' demands and AM's performance at a time. The inter-relationships between these variables, corresponding to market valuation process (Demand and Supply of distributed AIP equities and other Instruments) would influence the fund raising capabilities of the AIP.

As seen from the dynamics from the “Trading process of AIP securities” through this visual tool, the AIP platform thus provides “transparency”, valuations capabilities of “Weighted Average” performances from the nine AM combinations.

The Dynamics (Market Determination of AIP's Value)

Understanding the dynamics would be better served by looking into the characteristics of the following:

Initial Floor Price:

This is a price established after earnings have been declared and corresponding to future “Growth” potential. That is to say, The Earnings here is “Net” and on-going Growth is influenced by both the Liquidity and Leverage curves placed against the center pool of the Pyramid.

Adjusted Floor Price

This is the price after having taken the Leverage and Liquidity difference and when Leverage is Greater than Liquidity, the difference would have been further subtracted by a factor from the earlier initial floor price, reflecting the NPV of future earning potential range against Gearing outstanding at that particular point in time. In the event when Liquidity>Leverage, the difference between the two would have been added to the floor price thus establishing the new adjusted price floor that provides “comfort Zone” for investors bidding for AIP instruments.

Adjusted Range

Technically, this is the comfort Zone whereby Investors recognize an AIP trading range with actual Leverage and Liquidity influencing the price position. This Range effectively encourages investing interest if it were wide. Likewise, the narrower the range would imply increased risk because there could have higher leverage against prospective earnings or low liquidity to fund Growth in respect to prospective earnings.

The difference between this Range to that of the “Gap” between Liquidity and Leverage curves represents the “sustenance” principle of the AIP. The difference between the two curves would have been adjusted by the dynamics of the “Averaging effect” between the nine AM combinations. This is significant in the AIP valuation dynamics as its perspective deviates from that of the conventional “Prospective Price Earning Ratio” principle as seen in other investment portfolios. The rationale for the adjustment is that it provides additional “comfort” to investors in terms of a funding range against initial Investors' risk to return consideration. That is to say, “Conservatism” as a paramount concern has been extended. The process would either instill confidence from the investing public or it could negatively affect the AIP's valuation if market overacts against weak Growth potentials of an AIP. This range serves to provide another level of protection to Investors in that they can recognize the variance or additional risk to the existing risk level they are taking in consideration of a particular investing interest in the AIP's three range of Investment choices: IH, NI or IL.

Leverage and Liquidity as intervening variables against Earnings in AIP

The characteristic here is that Investors, when identifying the difference between both elements at a particular point in time, would have established if their current risk profile needs to be “reconsidered” and switch their investing interest to either a higher gear into higher risk; like in IH where composition of equity is greater than Debt, or to reduce their risk level by getting into more conservative platform with more Debt than Liquidity; IL.

Earnings Level

This is a Net figure of the “Weighted Average” of the AIP's performance at a point in time.

“DO”

It represents the Average Debt position of an AIP from “O” base measured against future AIP's commitment for the nine AMs. This level is established after the discounted effect from projected future earnings and impacts the leverage and Liquidity position of the AIP.

Simulating Value Creation Process Within the AM Model and the AIP:

Alliance investment portfolio management process requires a system of diagnostic procedure that can analyze sensitive financial elements to the iterative nature of alliance dynamics within the confine of an alliance investment portfolio, or AIP. The required model must be able to relate alliance situations to achieving realistic financial objectives expected by both Investors and Management.

Objective here is then to address correlations between “strategies” (Harvest, Aggressively pursuing, Focused and Divest) and “pricing dynamics” (demand affecting price of AIP) affecting the “Repositioning benefits” (switching of alliance between cells) within the AIP, and through market demand, their association therein with the various AM combinations that contribute to the value creation process.

The fundamental assumption here is to acknowledge that in so far as the AIP is concerned, the “DO” point (depicted in many financial theories as equivalent to “risk free asset” is the cost of AIP's Total Debt adjusted by the Leverage and Liquidity differentials, before the AIP's Earning at a particular point in time is evaluated. This is visually seen to be the line below the Earning indicator and this is also where the Leverage and Liquidity points begin.

Visually, the diagnostic process can be demonstrated through the multidimensional model by the interaction of liquidity and leverage curves to earnings. The economic objective of AIP is the maximization of its shareholders' wealth while generating appropriate funding for each alliance mix combinations as reflected through the nine cells or the 3×3 matrix. The premise applied across the board in evaluating the AIP takes into account the discounting of future income stream at an appropriate rate, adjusted for inflation and the “differentials” between “Leverage and Liquidity functional relationships” generated by the AIP economic entity on a Weighted Average basis to reflect the Net “Earnings” level. Hence, valuation methodologies retain the legitimacy of the NPV approach.

We also assume that the market value of AIP, reflected through demand of its common shares, represents the present value to the expected earnings stream from the Alliance Mix within the AIP is net of interest payments to debt holders. The interest payout ratio as such has been computed within the parameters of weighted average Earnings.

Growth “Factor” within the Alliance Mix combinations is a guidance to gage future (mid to long term) earning stream. This takes into account the interrelationships between Leverage and Liquidity guided by interest rate or the financial cost of capital on future profitability of AIP and AM combinations.

To simulate the combined market value contribution, we allocate a weighted average from the nine AM combinations' equities as well as their debt portions in respect to AIP's and then identify the weighted average cash flow position of AIP. Any difference derived would then have been generated from the difference between the two financial elements: Leverage and Liquidity. As such, the simulation is not on a static basis but dynamic.

The cash flow of the AIP and each AM contribution are projected through a limited time zone (between three years to five years in response to alliances' needs and mandates) adjusted on a weighted average basis because of the “Repositioning” principle allowed and accorded to AIP in response to increase or decrease in demand for AIP without disrupting fund flows to the various alliances within each AM combinations.

Effectively, unless an alliance is divested or Harvested where actual fresh capital inflow contributes to Growth of AIP and its AMs, each alliance continues to receive fund in accordance to agreements made earlier while finding process is continuously reflected through market perceptions of AIP's valuation. The simulation process is depicted visually in the multidimensional model.

As such, the actual value of AIP, assuming the Net cash flow ele ments, is n et contribution against leverage created by AM generating earnings. What this that as long as AM can generate Growth to justify Leverage, within acceptable parameters of earnings expectation, positive net cash flows (difference from Leverage and Liquidity curves movements as seen visually), AIP would be able to continue to attract investors, hence, the continue improvement of AIP's valuation. The interlocking relationship between leverage and liquidity of the AIP is thus very significant.

By the same argument when we assume that cash flow element is an important consideration here at each AM, we also assume that each AM generates positive earnings and have ROE greater than its cost of capital, (Adjustment is dynamic through the “crossing” of both leverage and liquidity curves) such that their individual terminal value should be the combined equity book value of AIP at the end of each planning period. Likewise, each AM's income stream, reflected through the AIP's stream of cash flows on an weighted average basis, is discounted by a factor incorporating both the prevailing cost of fund and the weighted risk combined of the nine different cells composite structure; ie, the percentage of debt to equity ratio each cell. The dynamic process is demonstrated visually through the multidimensional matrix dynamic process.

The AIP's “Market to Book Value” Model of Valuation:

There are two perspectives to this AIP here.

First is the contribution from AIP as whole, to Investors' choice and second, contributions at each AM combinations. Both processes simulated by AIM process.

Contribution from AIP itself is the weighted average of the contribution from the nine cells adjusted to net debt position from the earnings multiplied by a Growth factor as perceived by market demand from Investors from either “IH, IM or IL” levels where each significantly carries different risk profile as reflected. Market valuation is seen with effect from the “repositioning” of AM within a sector, (IH to AMH, AMM, AML or cells # 1, 2, and 3). The increase in demand for a sector inevitably leads to shifting of boundary into another sector. Take this situation where increase in demand by investors of IH, would cause boundary to expand into IM or (IM to AMH, AMM, AML or cells# 4, 5 and 6). With the increase demand, the market valuation would have increased the market price of AIP generated from expected Growth of the portfolio from increased activities stimulating further growth of AM.

Putting it in simpler terms, improved AM's performance in either cell 1, 2 or 3 would have alerted the investing market, through individual AM's performance or as an average improved performance of the AIP. Investors bidding for the limited AIP shares in the market would have increased the price of the AIP.

The fact that the AIP is structured to allow investors the choice of also directly investing into AM combinations, would have allowed secondary performance valuations. In the above example, any success or above expected performance within cell # 1 would have increased value of AM combinations of IH to AMH or simply cell #1. Investors' choice of investing in AIP to receive the average benefit of AIP for such a performance from Cell #1 is thus deemed to be another impact on AIP apart from the cell #1's contribution. For Cell #1 to return to equilibrium, thus allowing the AIP price to adjust back to equilibrium, Cell #1, with its heavy on Equity than on Debt structural composition of invested instruments, could “Harvest” equities of alliances that fetch above market expected valuation. Such a Harvest strategy would generate cash return, or a choice of share swaps with others, hence no cash return but positioning the additional new equities within the 9 cells to generate a potentially higher earnings for AIP. This strengthens the valuation of both AIP and the particular cell, which now carries the equity of the alliance. The repositioning would have conditioned the AIP market valuation process back to equilibrium.

The mathematical process is simply taking at the numerator, the current market value of the AIP's shares given the Investors' perspective on future Growth potential, corresponding to their assessment of future earnings and interest payments to be generated from the AM within the AIP's composition from the 9 different combinations. This has a Factor incorporating “Risk average” profile called “R”. The market to Book value model as such is:

Expected Future Earnings (net of interest payout and multiplied by “R”)}AIP's invested sum in the nine alliance mix combinations

After adjustment to payout ratio, and if future income stream is expected to yield a return in line with the High end, of the risk-return Range within Investors' risk profile, we would see a market to book value profile (or AE/AB) of AIP is in excess of one. This also demonstrates that Growth is above expectation and thus creating value for shareholders

When AE/AB is less than one, it implies the future income stream to AIP is below the benchmark provided for thereby reducing Investors expectation within the Range. It however does not mean that Investors would get a Negative return but that they would likely receive a return at the low end of the risk Return Range. This would imply the return could be in line with yield from Debt instruments prevailing.

When AE/AB is equal to one. It implies that the return would be in the mid-range of Investors' expectation. The AIP is at equilibrium in respect of market value to earning. The portfolio is also at Optimum implying that any Growth prospect would stimulate investors' interest still but not to a degree that would have been expected by Investors' of High Risk profile who would expect higher return for the higher risk they would be prepared to take. The AIP's equilibrium is achieved when “repositioning” of alliance mix combinations is put back in line. This is done through the various four strategies as recommended by the AIP specialists. This situation can be improved when new alliances are added to Cell 1, 2 or 4 with cells 3, 5 and 7 adjusting from Debt to Equity. This shifting of portfolio combinations within each cell produces their own variance between alliance mix thereby reducing or increasing risk and the corresponding adjustments is reflected at the final composition of the Equity to Debt ratios within the AIP. This adjustment process inevitability also shifts the Leverage and Liquidity curves based on the expected cash flow to increased borrowings to fund the various alliance mix. The net effect at equilibrium is when the net leverage level is adjusted to the earnings of AIP producing an adjusted floor price that is minimum.

Any market variations generated from Investors interest would then increase bidding for the shares of AIP (reflected in the increase in price of AIP) beyond the adjusted floor price. This is the conservative pricing adjustment model to deflate unjustifiable price movements of the AIP. This process in itself strengthens the AIP and provides confidence to the investing public. As for the Alliance Mix, there is also the comfort zone provided to ensure that funds would continue to flow into to support growth of their alliances' operations. The adjustment is iterative between leverage to liquidity needs. Adjustments would be upwards for increased comfort zone if Liquidity were greater than Leverage positions. However, this would also imply that an opportunity cost from higher liquidity to AIP's Growth. This adjustment is in line with Leverage as a financial principal in generating Growth. Too much liquidity as such carries a cost to the AIP if it is not appropriately “offset” with increased borrowings for Growth.

It is important to acknowledge that the essence of this model is that market reaction to AIP will affect both leverage and liquidity positions and comfort zone to the AM combinations indirectly. However, the direct impact from Investors' choice is reflected in the pricing of the AIP and this reflects a value placed by investors on the alliance mix performances. Because of the limited AIP equity shares and Bonds that may be available and as distributed in the market at a particular point in time, the price bid by investors would affect the perceived value of the AIP's valuation. But, the Gap between AIP's correlating factors of both “Leverage to Liquidity” provides the financial comfort to investors and alliance partners alike since that comfort zone is equated to the minimum price above earnings that justify investors' valuation in the first place. This is also the significant point of the AIP. The iterative forces between the buyers and sellers, influenced by key select financial elements projected, would adjust themselves to reflect the comfort zone for growth support to the AIP value.

The net present value of the dividend stream is another unbiased assessment of the market value of the AIP. This does not distort the differences generated from payout ratio, which is already taken into account from the computation of earnings before dividend payment adjustment. This is possible because of the corresponding adjustments that goes on between the 9 AM combinations that provides an on-going valuation with the earnings level reflected iteratively through the indicators by means of adjustments to the earnings of the AIP. Growth in AM has a direct and significant impact on the valuation of the AIP.

Investors' perception of Growth potential is reflected in their choice of investing instruments; be it through IH, IM or IL at the AIP level, or as direct participants into the AM combinations.

Any Growth potential of AM through AIP would be reflected in the share price of AIP. However, investors who have a direct interest in some AM combinations could take a conservative approach investing through the AM's instrument combination of Bonds or Convertibles, could still have their choice reflected within a risk to return profile of the AIP.

The corresponding relationships between AM to AIP provides the strength in providing an Optimal AIP position at cell #5.

Taking an example of how Growth impacts on AIP through AIM. Growth is reflected through the profitability status within the AIP. On a weighted average and a direct reflection from a particular AM combinations, Growth “Propels” future Growth and AIP's investors would react to increasing demand for the AIP's instruments. But, the impact is on the return on equity. With the finding barometer moderated from Leverage to Liquidity movements that influences Earnings, Growth will significantly increase market value of AIP.

The comfort to the investors is that as long as the adjusted mechanism of Leverage of Liquidity secures a range of comfort zone, the AIP specialists would not “over gear beyond what they have outstanding”. If the Growth is through Debt financing, and the liquidity position, after deducting expected interest payment, still falls within the “Leveraging” range within a AM combinations, the weighted average effect would still show room for gearing but to a lesser degree. As such, the AIP specialists could exercise “focused strategies” to reposition the AM's combination across boundaries thereby releasing “pressure” from one AM to another causing a gradual move towards optimality across the nine AM combinations.

The Optimal AIP position hence also reflects AM combinations divesting when ROE of a particular AM combinations is below the cost of capital. It repositions its AM to other cells within the AIP. As such, it would be inappropriate to say that cell #9 is weak because of its collection of Debt instruments and that Cell #1 is high risk thereby its combinations should provide higher returns to compensate for Investors' risks. This is because each cell, by its own characteristic as determined by the risk to return profile seen from the second methodology already established an appropriate combination for a particular cell. As such, the higher Debt to Equity ratio in cell #9 is not necessary bad as long as the risk adjusted to ROE and related financial considerations reflect a return acceptable by Investors within their risk profile, would still encourage further investments into those alliances. The fact that each cell has its opportunity to be repositioned and to be converted with a particular financial instrument to another form corresponding to either higher or lower degree of risk to return ratio already allows for each cell to self sustain within the AIP. The method of simulating the AIP is thus iterative in nature and investors does not have to respond to static information base but to recognize the dynamics at play to facilitate in their investment decision process.

Attachments:

Technical Drawings on the three phases form an integral part of this submission. The drawings explain the AIM process through the three phases. Drawings explaining the iterative nature of the dynamics have also been presented. Three tables together with thirtysix other drawings with notes explain and establish relationships within the AIP dynamic processes.

I claim:

1. A method for simulating and managing a portfolio of assets including alliance investments, said method comprising the steps of:
(1) determining the financial fit of a plurality of alliance investments by categorizing thereof according to a 3×3 matrix nine combinations of alliance mix, financial fit being defined as the existence of synergies of capital structures of between select alliances within a portfolio of alliance investments;
(2) testing each proposed alliance through a geometric test for sustainability of growth, said geometric test correlating the relationship among risk, return expectation, financial instrument and interest cost of said proposed alliance in establishing the asset mix of said portfolio of alliance investment; and
(3) correlating the liquidity to be provided by investors with a vertical axis through the center of said 3×3 matrix in creating a 3×3×3 spatial representation of liquidity and leverage relationship for alliance investments, the inter-relationship amoung the variables corresponding to the market valuation of said alliance investments,
whereby said method provides financial information of said portfolio of alliance investments transparently and dynamically.

2. The method as in claim 1 wherein said each asset comprises at least one portfolio of alliance assets.

3. The method as in claim 1 wherein said 3×3 matrix of alliance mix has one of its axis corresponding to the range of liquidity to be provided by investors and the other axis corresponding to the range of leverage an alliance asset may be financed.

4. The method as in claim 1 wherein said geometric test comprising the simulation of introducing at least one ball into at least one prism, said ball corresponding to at least one alliance, the weight of said ball being influenced by at least eight elements, said eight elements including at least four variables for enhancing growth and at least four variables for sustaining growth of select alliance, said prism further comprising at least four planes, said planes corresponding to risk, return expected, proposed investment instrument and intrest cost respectively.

5. The geometric test in claim 4 wherein said ball and prism sumulates an iterative process of strengthening the captial structure of an alliance, said ball being first introduced into said prism by bouncing off the risk plane, then to the return expected plane, and finally off the proposed investment instrument plane.

6. The method of claim 1 wherein said 3×3×3 spatial representation of liquidity and leverage relationship for alliance investments simulates the sustainability of growth of alliance within a portfolio of alliance investment by reconciling the extent of liquidity with the return expected of proposed alliance mix within a predetermined interest environment.

7. The method in claim 1 wherein said 3×3×3 spatial representation of liquidity and leverage relationship for alliance investments provides a transparent valuation of securities that are based on a portfolio of alliance investment by determining the weighted average of the performance of said nine combination of alliance mix.

8. The method in claim 1 wherein said 3×3×3 spatial representation of liquidity and leverage relationship for alliance investments simulates value creation process by shifting boundaries between cells representing said nine combination of alliance mix and by applying said ball an prism test.

9. The method in claim 1 wherein said 3×3×3 spatial representation of liquidity and leverage relationship for alliance investments simulates the market to book value valuation by predicting the secondary effects on remaining eight combination of alliance mix once the performance on one such combination is known and assuming that overall portfolio reverts to equilibrium.

10. The method in claim 1 wherein said the simulation results and information of said alliance mix is provided wirelessly.
